(19) United States
(12) Patent Application Publication
(10) Pub. No.: US 2017/0205740 A1
(43) Pub. Date: Jul. 20, 2017

(54) Systems and Methods for Fuser Power Control

(71) Applicant: Lexmark International, Inc., Lexington, KY (US)

(72) Inventors: Jichang Cao, Lexington, KY (US); Paul Wesley Etter, Lexington, KY (US)

(21) Appl. No.: 14/997,836

(22) Filed: Jan. 18, 2016

(51) Int. Cl. G03G 15/20

(52) U.S. Cl. CPC G03G 15/2039

(57) ABSTRACT

A method of controlling the temperature of a fuser is disclosed. The fuser is driven with a repeated sequence of half-cycles of an AC line voltage. The sequence contains partial half-cycles and does not have a repeating sequence shorter than twenty half-cycles. The disclosed sequences provide fine granularity of fuser power while generating low power-line flicker and harmonics. Other methods and systems are disclosed.

### CROSS REFERENCES TO RELATED APPLICATIONS

None.

### BACKGROUND

1. Field of the Disclosure

The present disclosure relates generally to power control of AC line powered loads and more particularly to fuser power control in an imaging device.

2. Description of the Related Art

Electrophotographic printers operate by depositing small particles of toner on paper that are fused to the paper by a fuser. The fuser is heated to aid in the fusing process. Fusers typically consume hundreds of watts of power and are often driven directly from an AC line voltage such as 230V at 50 Hz in Europe. At the start of a print job, the fuser is rapidly heated to an operating temperature by driving one hundred percent power to the fuser. Once the fuser is at the operating temperature, the fuser is driven at much lower power to maintain the operating temperature. The fuser is switched on and off to provide a lower average power. This switching causes varying voltage drops in the impedances in a building's power delivery network. The voltage drops may cause light bulbs to flicker, which may be objectionable to the building's occupants.

To reduce flicker, a method of power control known as phase control may be used. In phase control, the power may be switched on at various points in the AC waveform, not just at the zero crossing. This effectively makes the voltage drops fluctuate at 100 Hz for Europe's 50 Hz line frequency. The 100 Hz frequency is high enough that the flicker is generally not perceptible. However, objectionable line harmonics may occur which may interfere with the operation of radio frequency devices. Some European countries require products to pass tests for flicker and harmonics defined in IEC-61000.

Fuser power continues to increase as printer speeds increase. It is difficult to pass IEC-61000 using simple phase control for a fuser greater than 1000 watts. Prior art algorithms had limited granularity of fuser power e.g. greater than ten percent jumps between available power levels that met IEC-61000. This limited granularity caused temperature oscillations as too much or too little power was applied to control fuser power. The temperature oscillations may degrade fusing quality. What is needed is a method to drive a high-power fuser with finer granularity that passes IEC-61000.

### SUMMARY

The invention, in one form thereof, is directed to a method of operating a fuser using partial half-cycles of a 50 Hz AC voltage including driving the fuser with a drive sequence of partial half-cycles of the 50 Hz AC voltage having a first partial half-cycle and a second partial half-cycle. The first partial half-cycle supplies more power to the fuser than the second partial half-cycle. The drive sequence has a repeated sequence having a duration of at least 200 mS having the first partial half-cycle and the second partial half-cycle. The repeated sequence does not have a shorter repeating sequence having the first partial half-cycle and the second partial half-cycle that is shorter than the repeated sequence.

The invention, in another form thereof, is directed to a method of driving a fuser at a desired power using half-cycles of a AC voltage source including determining if the desired power is equal to a first target power and if the determination is affirmative then driving the fuser with a first repeating sequence of half-cycles having a first shortest repeated sequence of twenty half-cycles; and determining if the desired power is equal to a second target power and if the determination is affirmative then driving the fuser with a second repeating sequence of half-cycles having a second shortest repeated sequence of ten half-cycles. The first repeating sequence has a first partial half-cycle and a second partial half-cycle that delivers less power to the fuser than the first partial half-cycle and the second repeating sequence has a third partial half-cycle.

The invention, in yet another form thereof, is directed to a method of controlling a temperature of a fuser including measuring the temperature of the fuser; computing a desired power using the measured temperature; retrieving a first sequence of half-cycle powers from a lookup table using the desired power as an index into the lookup table, the first sequence of half-cycle powers contains twenty half-cycles; driving the fuser using the first sequence of half-cycle powers; waiting until all twenty half-cycles of the first sequence of half-cycle powers have been driven to the fuser, then retrieving a second sequence of half-cycle powers from the lookup table and driving the fuser using the second sequence of half-cycle powers.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a block diagram of an imaging system including an image forming device according to one example embodiment.

FIG. 2 is a prior art voltage waveform for supplying power to a fuser.

FIG. 3 is voltage waveform for supplying power to a fuser according to one example embodiment of the present disclosure.

FIG. 4A, FIG. 4B, and FIG. 4C, together forming FIG. 4, is a table of half-cycle sequences according to one example embodiment of the present disclosure.

FIG. 5 is a method of controlling the temperature of a fuser according to one example embodiment of the present disclosure.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

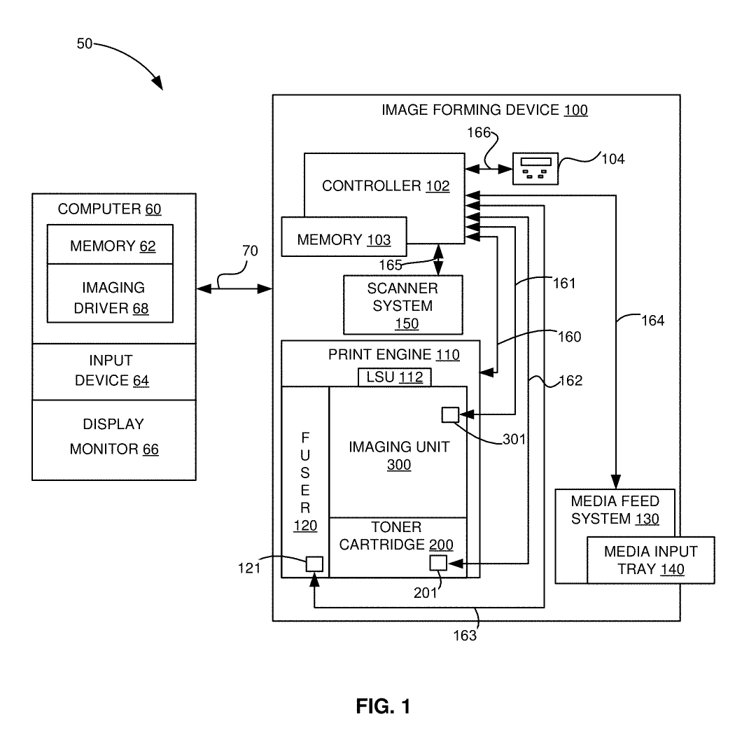

Referring to the drawings and particularly to FIG. 1, there is shown a block diagram depiction of an imaging system 50 according to one example embodiment. Imaging system 50 includes an image forming device 100 and a computer 60. Image forming device 100 communicates with computer 60 via a communications link 70. As used herein, the term “communications link” generally refers to any structure that facilitates electronic communication between multiple components and may operate using wired or wireless technology and may include communications over the Internet.

In the example embodiment shown in FIG. 1, image forming device 100 is a multifunction device (sometimes referred to as an all-in-one (AIO) device) that includes a controller 102, a user interface 104, a print engine 110, a laser scan unit (LSU) 112, one or more toner bottles or cartridges 200, one or more imaging units 300, a fuser 120, a media feed system 130 and media input tray 140, and a scanner system 150. Image forming device 100 may communicate with computer 60 via a standard communication protocol, such as, for example, universal serial bus (USB), Ethernet or IEEE 802.xx. Image forming device 100 may be, for example, an electrophotographic printer/copier including an integrated scanner system 150 or a standalone electrophotographic printer.

Controller 102 includes a processor unit and associated memory 103 and may be formed as one or more Application Specific Integrated Circuits (ASICs). Memory 103 may be any volatile or non-volatile memory or combination thereof such as, for example, random access memory (RAM), read only memory (ROM), flash memory and/or non-volatile RAM (NVRAM). Alternatively, memory 103 may be in the form of a separate electronic memory (e.g., RAM, ROM, and/or NVRAM), a hard drive, a CD or DVD drive, or any memory device convenient for use with controller 102. Controller 102 may be, for example, a combined printer and scanner controller.

In the example embodiment illustrated, controller 102 communicates with print engine 110 via a communications link 160. Controller 102 communicates with imaging unit(s) 300 and processing circuitry 301 on each imaging unit 300 via communications link(s) 161. Controller 102 communicates with toner cartridge(s) 200 and processing circuitry 201 on each toner cartridge 200 via communications link(s) 162. Controller 102 communicates with fuser 120 and processing circuitry 121 thereon via a communications link 163. Controller 102 communicates with media feed system 130 via a communications link 164. Controller 102 communicates with scanner system 150 via a communications link 165. User interface 104 is communicatively coupled to controller 102 via a communications link 166. Processing circuitry 121, 201, 301 may include a processor and associated memory such as RAM, ROM, and/or NVRAM and may provide authentication functions, safety and operational interlocks, operating parameters and usage information related to fuser 120, toner cartridge(s) 200 and imaging unit(s) 300, respectively. Controller 102 processes print and scan data and operates print engine 110 during printing and scanner system 150 during scanning.

Computer 60, which is optional, may be, for example, a personal computer, including memory 62, such as RAM, ROM, and/or NVRAM, an input device 64, such as a keyboard and/or a mouse, and a display monitor 66. Computer 60 also includes a processor, input/output (I/O) interfaces, and may include at least one mass data storage device, such as a hard drive, a CD-ROM and/or a DVD unit (not shown). Computer 60 may also be a device capable of communicating with image forming device 100 other than a personal computer such as, for example, a tablet computer, a smartphone, or other electronic device.

In the example embodiment illustrated, computer 60 includes in its memory a software program including program instructions that function as an imaging driver 68, e.g., printer/scanner driver software, for image forming device 100. Imaging driver 68 is in communication with controller 102 of image forming device 100 via communications link 70. Imaging driver 68 facilitates communication between image forming device 100 and computer 60. One aspect of imaging driver 68 may be, for example, to provide formatted print data to image forming device 100, and more particularly to print engine 110, to print an image. Another aspect of imaging driver 68 may be, for example, to facilitate the collection of scanned data from scanner system 150.

In some circumstances, it may be desirable to operate image forming device 100 in a standalone mode. In the standalone mode, image forming device 100 is capable of functioning without computer 60. Accordingly, all or a portion of imaging driver 68, or a similar driver, may be located in controller 102 of image forming device 100 so as to accommodate printing and/or scanning functionality when operating in the standalone mode.

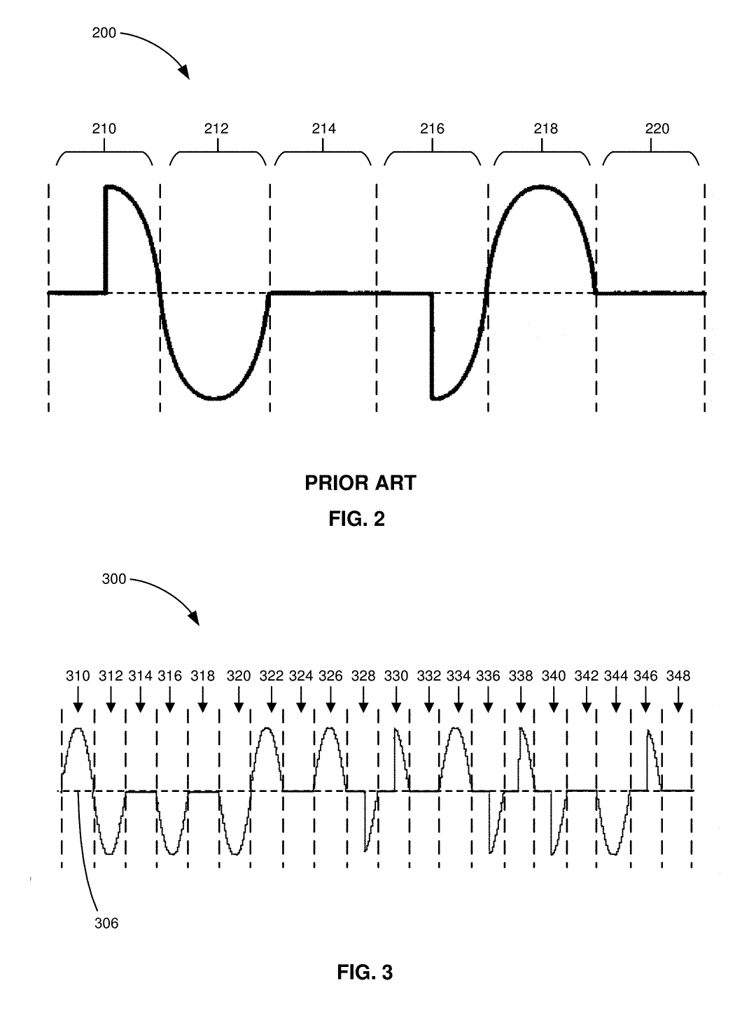

FIG. 2 shows a prior art voltage waveform 200 for supplying power to a fuser. The waveform 200 contains six half-cycles 210, 212, 214, 216, 218, 220. A half-cycle of a 50 Hz AC voltage source is a 10 mS portion of the voltage waveform. The end of the portion aligns to when the AC voltage source is zero volts e.g. the portion is aligned with zero crossings of the AC voltage source. Some half-cycles are zero volts during the entire half-cycle and are aligned with an integer multiple of 10 mS of a prior zero crossing of the AC voltage source. Half-cycle 210 is a partial half-cycle that supplies fifty percent of the power of a full half-cycle. Half-cycle 212 is a full power half-cycle. Half cycle 214 is a zero power half-cycle. Half-cycle 216 is the inverse of half-cycle 210. Half-cycle 218 is the inverse of half-cycle 212. Half-cycle 220 is a zero power half-cycle. The average voltage of these six half-cycles is zero i.e. waveform 200 has zero DC content. This is necessary to avoid an imbalance in the flux of a line transformer, which could cause overheating. Waveform 200 has significant harmonic content and, depending on the wattage of the driven fuser, may cause failures when the fuser is tested under IEC-61000. Waveform 200 delivers fifty percent power.

FIG. 3 shows a voltage waveform 300 of the present disclosure. Waveform 300 also delivers fifty percent power to a fuser and has significantly lower harmonic content than waveform 200. Zero volts 306 is shown by a horizontal dashed line. Half-cycles 310, 312, 316, 320, 322, 326, 334, and 344 are full power half-cycles. Half-cycles 314, 318, 324, 332, 342, and 348 are zero power half-cycles. Half-cycles 328 and 346 are twenty-five percent power half-cycles. Half-cycles 330 and 336 are thirty-six percent power half-cycles. Half-cycles 338 and 340 are thirty-nine percent power half-cycles. To drive steady fuser power at fifty percent power, waveform 300 is repeated. Note that waveform 300 may be inverted e.g. half-cycle 310 may be negative, half-cycle 312 may be positive, etc. It was found that a twenty half-cycle pattern is the shortest pattern that gives satisfactory performance under IEC-61000 for many power levels to a 1200-watt fuser. A shorter pattern may be adequate for a lower power heater, and a longer pattern may be necessary for a higher power heater.

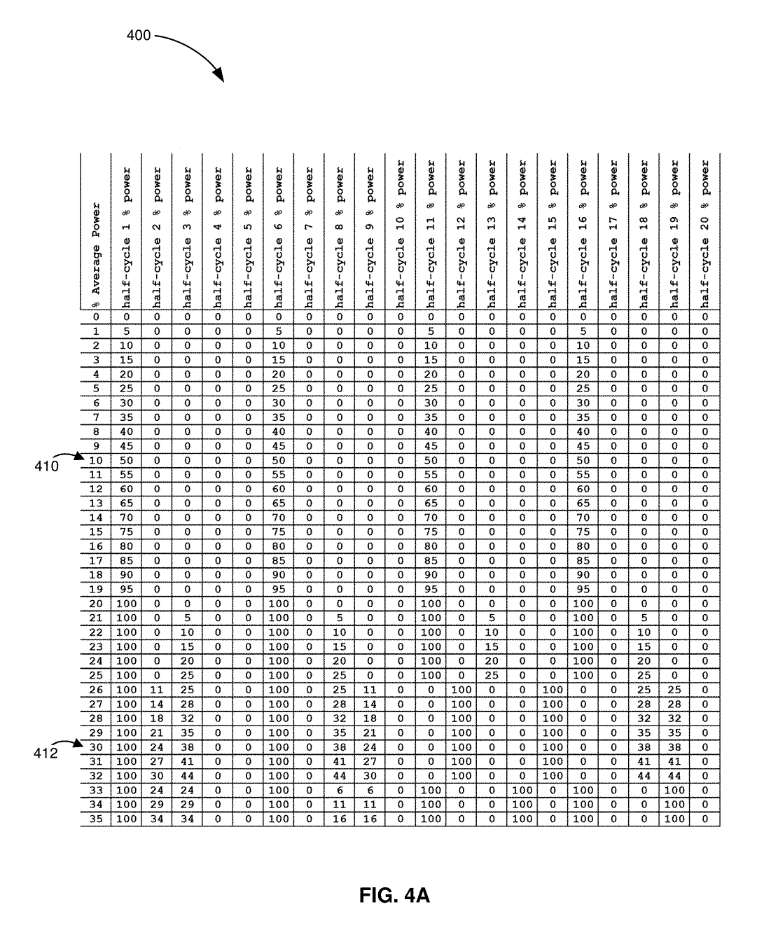

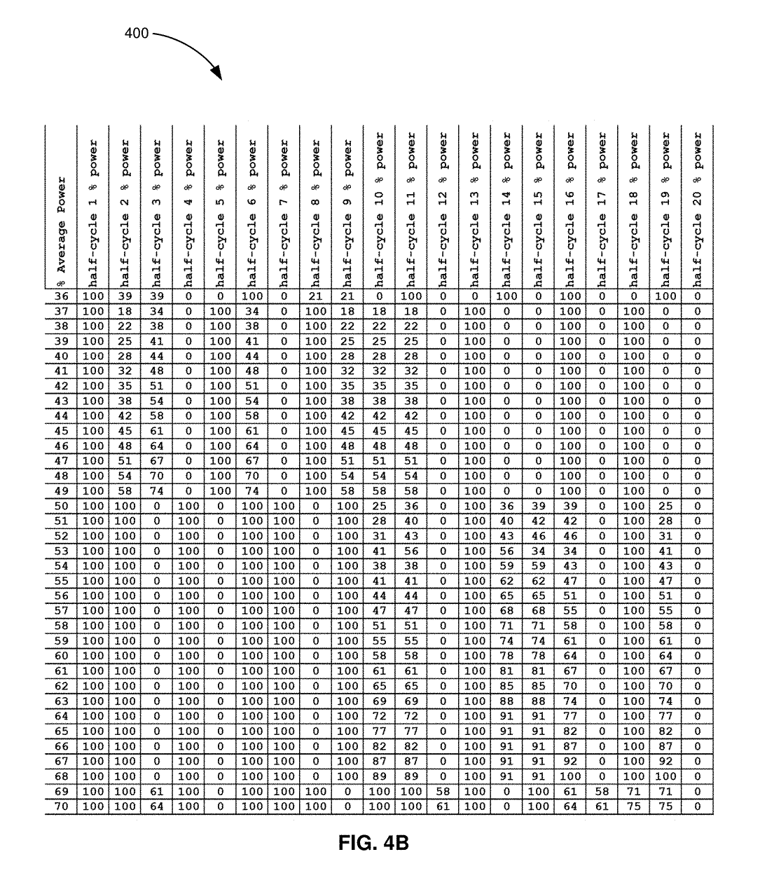

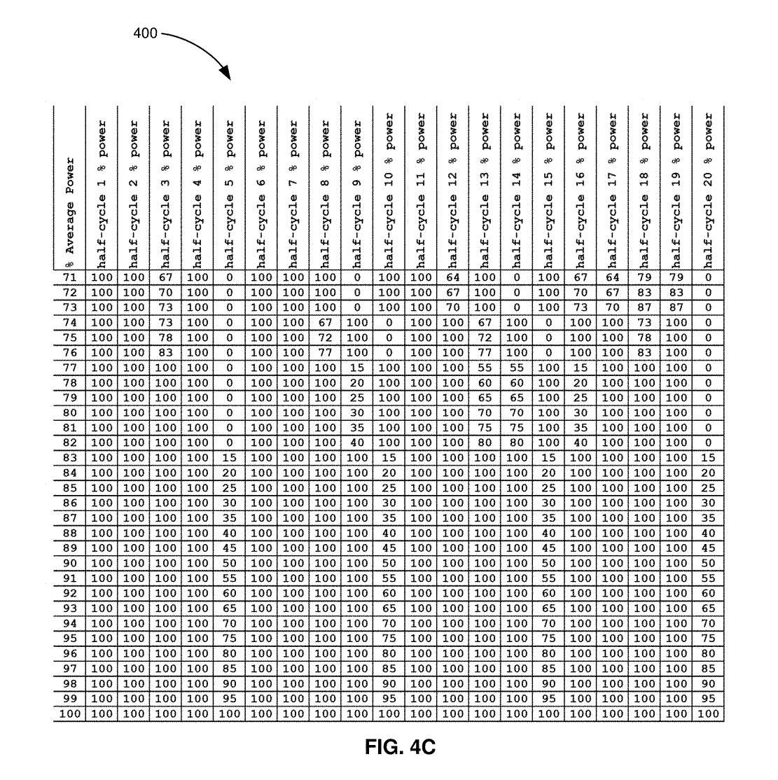

FIGS. 4a, 4b, and 4c together form FIG. 4, which contains a table 400 of half-cycle sequences that repeat after twenty cycles. Table 400 has half-cycle sequences for average powers in one percent increments. By using table 400, a control algorithm may control the temperature of a fuser with little overshoot since table 400 contains fine granularity. Each half-cycle sequence may start on a positive or negative half-cycle with each sequential half-cycle alternating polarity. A 1200 watt fuser passes IEC-61000 when driven with the half-cycle sequences in table 400.

Once a half-cycle sequence is started, it is preferred to complete the sequence before starting a new sequence. This avoids introducing DC content and maintains low harmonic power. Some sequences have a shortest repeated sequence with zero DC content of ten half-cycles, such as, for example, ten percent average power sequence 410. Some sequences have a shortest repeated sequence of twenty half-cycles such as, for example, thirty percent average power sequence 412. A control algorithm may determine that the desired power to the fuser is ten percent and drive the fuser with the first ten half-cycles of sequence 410. The control algorithm may then determine that the desired power to the fuser is thirty percent and drive the fuser with the twenty half-cycles of sequence 412. In this way, the control algorithm may respond more quickly to changes in the desired power since, for some sequences, it may not be necessary to drive all twenty cycles. Quicker response may reduce overshoot and provide superior control.

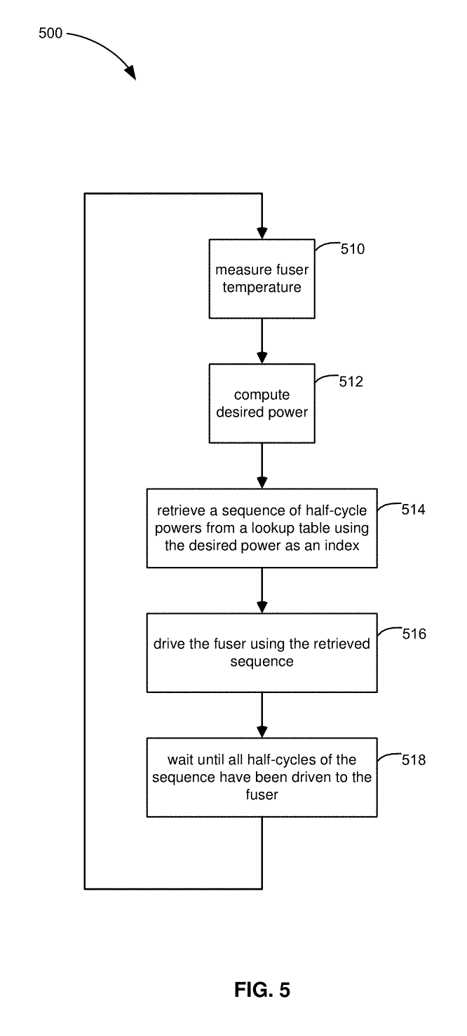

FIG. 5 shows an example embodiment of a method of controlling the temperature of a fuser according to one embodiment. Method 500 controls high wattage heaters while generating low harmonic content on the AC supply network.

At block 510, the fuser temperature is measured. The measurement may be a contact temperature measurement. Alternatively, a non-contacting temperature measurement may be used. At block 512, the desired power to be delivered to the fuser is computed. The computation may include well-known control algorithms such as a proportional controller, a proportional/integral controller, a proportional/integral/derivative controller, etc.

At block 514, a sequence of half-cycle powers is retrieved from a lookup table using the desired power as an index into the table. For example, the lookup table in FIG. 4 may be used. If, for example, the desired power is thirty percent power, sequence 412 may be retrieved. Alternatively, instead of a lookup table, a determination may be made whether the desired power is equal to a first target power and if so then a first half-cycle sequence is used. A second determination may be made whether the desired power is equal to a second target power and if so then a second half-cycle sequence is used.

At block 516, the fuser is driven using the retrieved sequence. At block 518, the method 500 waits until all half-cycles of the sequence have been driven to the fuser. It is preferable to wait until the sequence completes to avoid adding DC content to the fuser voltage to avoid imbalance in line transformers. The method 500 repeats at block 510. Controller 102 may be configured to perform one or methods of the present disclosure. For example, controller 102 may be configured to execute program instructions that perform one or more methods.

The foregoing description illustrates various aspects and examples of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

What is claimed is:

1. A method of operating a fuser using partial half-cycles of a 50 Hz AC voltage comprising:
driving the fuser with a drive sequence of partial half-cycles of the 50 Hz AC voltage having a first partial half-cycle and a second partial half-cycle, the first partial half-cycle supplies more power to the fuser than the second partial half-cycle;
wherein the drive sequence has a repeated sequence having a duration of at least 200 mS having the first partial half-cycle and the second partial half-cycle, and the repeated sequence does not have a shorter repeating sequence having the first partial half-cycle and the second partial half-cycle that is shorter than the repeated sequence.

2. The method of claim 1, wherein the drive sequence has a third partial half-cycle that supplies more power to the fuser than the first partial half-cycle, and the repeated sequence has the third partial half-cycle.

3. The method of claim 1, wherein the fuser is a 1200-watt fuser and the duration of the repeated sequence is 200 mS.

4. A controller configured to perform the method of claim 1.

5. A controller configured to perform the method of claim 2.

6. A method of driving a fuser at a desired power using half-cycles of a AC voltage source comprising:
determining if the desired power is equal to a first target power and if the determination is affirmative then driving the fuser with a first repeating sequence of half-cycles having a first shortest repeated sequence of twenty half-cycles; and
determining if the desired power is equal to a second target power and if the determination is affirmative then driving the fuser with a second repeating sequence of half-cycles having a second shortest repeated sequence of ten half-cycles,
wherein the first repeating sequence has a first partial half-cycle and a second partial half-cycle that delivers less power to the fuser than the first partial half-cycle and the second repeating sequence has a third partial half-cycle.

7. A controller configured to perform the method of claim 6.

8. A method of controlling a temperature of a fuser comprising:
measuring the temperature of the fuser;
computing a desired power using the measured temperature;
retrieving a first sequence of half-cycle powers from a lookup table using the desired power as an index into the lookup table, the first sequence of half-cycle powers contains twenty half-cycles;
driving the fuser using the first sequence of half-cycle powers;
waiting until all twenty half-cycles of the first sequence of half-cycle powers have been driven to the fuser, then retrieving a second sequence of half-cycle powers from the lookup table and driving the fuser using the second sequence of half-cycle powers.

9. A controller configured to perform the method of claim 8.
